(19) United States
(12) Patent Application Publication
(10) Pub. No.: US 2011/0307558 A1
(43) Pub. Date: Dec. 15, 2011

(54) SHARED SOCIAL PROGRAM GUIDE

(75) Inventors: Guy G. Romano, Elmhurst, IL (US); Noel S. Massey, Carpentersville, IL (US)

(73) Assignee: MOTOROLA, INC., Schaumburg, IL (US)

(21) Appl. No.: 12/814,732

(22) Filed: Jun. 14, 2010

(51) Int. Cl. G06F 15/16

(52) U.S. Cl. 709/205

(57) ABSTRACT

Disclosed is a method whereby content-consumption information is gathered from members of a group. Based on the gathered information, a shared social program guide is created and presented to the member of the group. Group members interact with the shared social program guide to recommend and eventually to select content to consume. The selected content is then rendered to the content-consumption devices of the group members. The rendering is done in a coordinated fashion. To enhance social interaction, the shared social program guide can tell a viewer which other group members are currently available for consuming content. A communication channel can be set up among the group members to coordinate their choices or to allow them to discuss the content being viewed. In some embodiments, the shared social program guide accepts commands that alter the rendering of the chosen content. The altered rendering is coordinated among the viewers.

### FIELD OF THE INVENTION

The present invention is related generally to media consumption and, more particularly, to program guides informing media-consumption choices.

### BACKGROUND OF THE INVENTION

The amount of media content (e.g., broadcast television and radio, pre-recorded content, video on demand, webcasts) available for consumption is expanding at an alarming rate. Instead of having “nothing to watch,” a viewer finds that there is too much to watch or even to sift through in order to make a choice about what media to consume.

(Note that here “consume” is meant as a general term for any type of human interaction with a medium. It can include watching television, listening to radio, playing a computer game, talking or texting on a telephone, interacting with a web site, and the like. To simplify the present discussion, a media consumer is generally called a “viewer,” even when his medium of choice does not have a visual portion.)

The problems of too much choice that face an individual viewer are magnified when a social group wants to consume content together. The choices facing each viewer are magnified by the number of potential viewers in the social group, which makes the coordination of their choices a very difficult problem. “Social TV” (i.e., automatic recommendation systems based on user preferences) have been developed to address this problem, but have proven in trials to be inadequate or unsatisfying.

### BRIEF SUMMARY

The above considerations, and others, are addressed by the present invention, which can be understood by referring to the specification, drawings, and claims. According to aspects of the present invention, content-consumption information is gathered from members of a group, for example, a group of viewers in a social network. Based on the gathered information, a shared social program guide is created and presented to the member of the group. Group members interact with the shared social program guide to recommend and eventually to select content to consume. The selected content is then rendered to the content-consumption devices (e.g., televisions, set-top boxes) of the group members. The rendering is done in a coordinated fashion.

The information about content consumption can be gathered in a number of ways. For example, the power status of a content-consumption device tells whether or not content is currently being rendered (although it cannot tell whether anyone is actually viewing the rendered content). More directly, commands to select content (e.g., to a cable provider) can be captured and analyzed. Also relevant can be a list of content stored by a viewer (e.g., on a digital video recorder) or on-line ratings posted by a viewer.

In some embodiments, the members of the group can rate content items. The presentation of the shared social program guide reflects those ratings. These ratings may be made directly through the shared social program guide system or can be found in on-line postings.

To enhance social interaction, the shared social program guide can tell a viewer which other group members are currently available for consuming content. A communication channel can be set up among the group members to coordinate their choices or to allow them to discuss the content being viewed.

In some embodiments, the shared social program guide accepts commands that alter the rendering of the chosen content. For example, one member of the group can pause the playback or rewind it. The altered rendering is coordinated among the viewers.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a schematic of a device for consuming content and for gathering information on a user's content consumption; and

FIGS. 3a and 3b together form a flowchart of a method for creating and using a shared social program guide.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

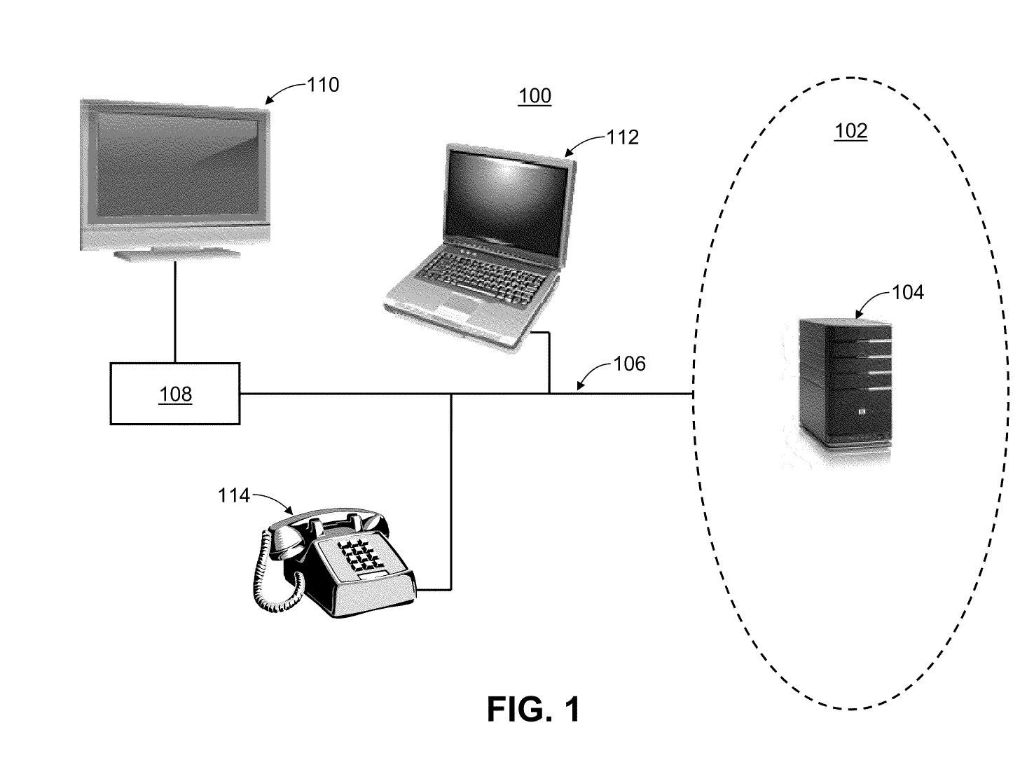

Aspects of the present invention may be practiced in the representative communications environment 100 of FIG. 1. Here, a cable television provider supports numerous communications services. Servers and other devices (represented by the single device 104) reside at the cable provider's “head end” 102. These devices (which are very complicated but are well known in the art) provide television and other services via a cable infrastructure 106 to the homes of cable subscribers. The cable infrastructure 106 supports two-way traffic: In addition to programming coming “down” the cable 106, commands go “up” to the head-end servers 104. The cable 106 can also support inherently bi-directional services when the head-end servers 104 provide connection to, for example, the public switched telephone network, the Internet, and to other services beyond those provided directly by the cable provider.

A typical subscriber may have one or more devices connected, directly or indirectly, to the cable infrastructure 106. A set-top box 108 generally receives television programs and provides a user interface (e.g., an interactive program guide) for selecting and viewing content from the cable provider. A digital video recorder (“DVR”) (not shown) can store programming for later viewing. Video content may be viewed on a television monitor 110. In some situations, a laptop computer 112 accesses web-based services via the cable 106. Most users will have a telephone 114 which may be supported by the cable 106, may be supported by a land line, or may be cellular.

The environment 100, though typical, is only representative. In general, a user may be supported by other communications media in addition to, or instead of, the cable 106 of FIG. 1. For example, a given user may also have a satellite television receiver, a cellular telephone, and a radio to pick up public broadcasts. In the present discussion, each member of a social group may have a unique communications set up.

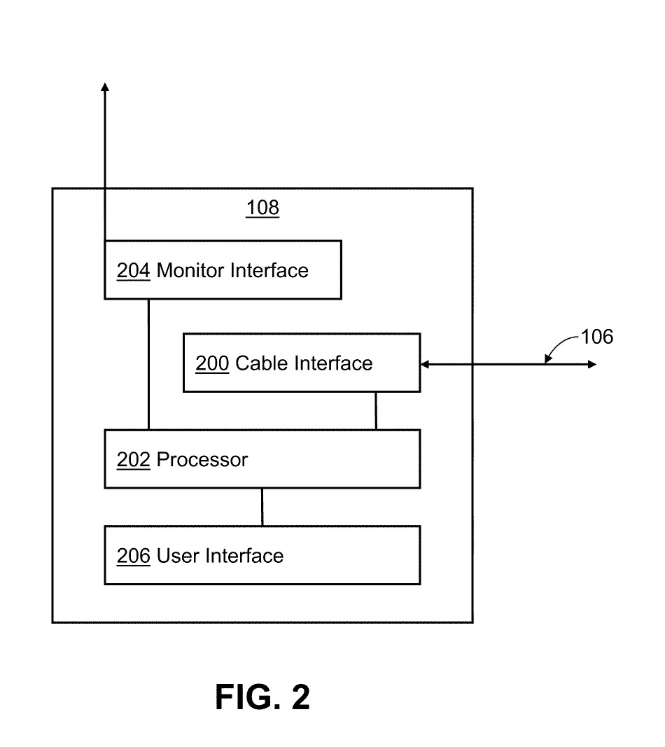

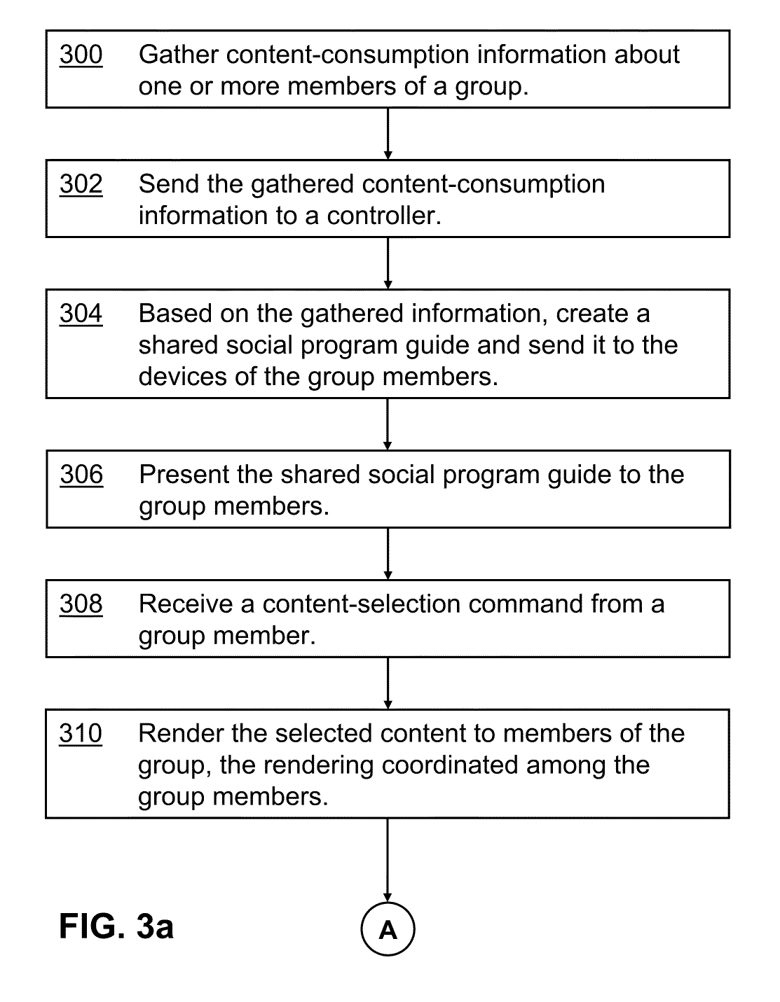

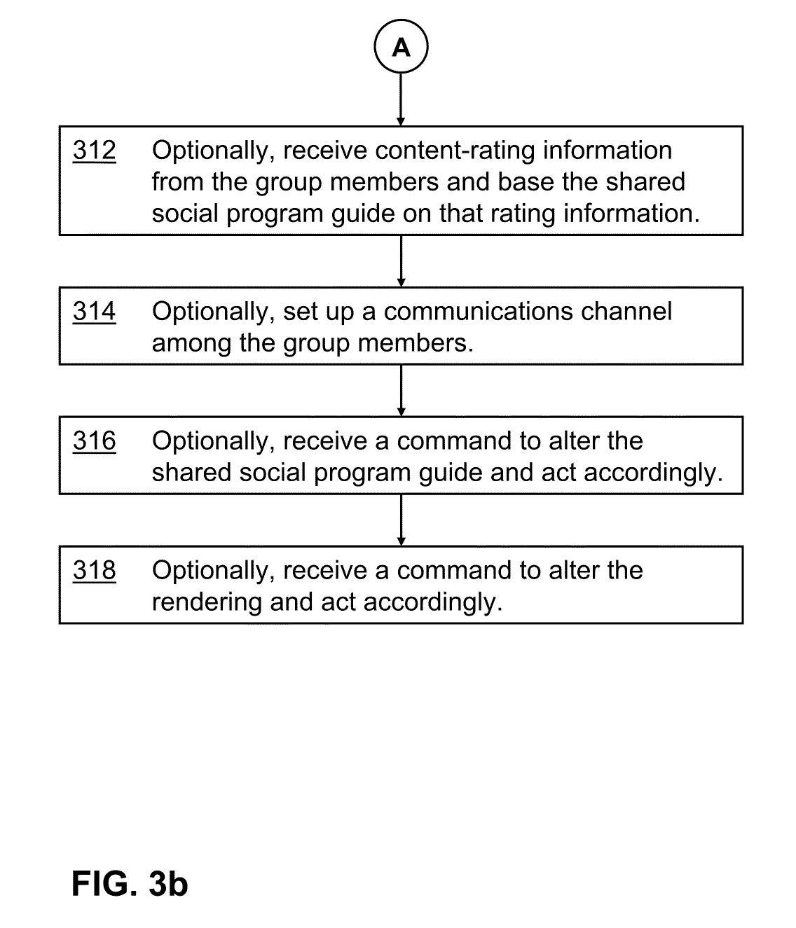

FIG. 2 shows the major components of a representative set-top box 108. The cable interface 200 receives programming from the cable infrastructure 106, sends commands to the head-end servers 104, and possibly supports bi-directional services. A processor 202 controls the operations of the set-top box 108 and, in particular, supports aspects of the present invention as illustrated in FIGS. 3a and 3b, discussed below. A monitor interface 204 drives the television monitor 110 of FIG. 1 to deliver video programming. In some embodiments, the monitor interface 204 is also used by the user interface 206 to support a user's interactions with the set-top box 108.

The method illustrated in FIGS. 3a and 3b includes many aspects of the present invention, including some optional aspects. In step 300 of FIG. 3a, content-consumption information is gathered from members of a group. The group may be, for example, a social network self-defined by its members.

Many types of content-consumption information are of interest here, and there may be many ways of gathering that information. As a first example, it is interesting to know exactly what each member of the group watches. This information may be gathered by the set-top box 108 when it monitors the commands sent through it to the cable servers 104. Also, the set-top box 108 may know when the television monitor 110 is powered on and powered off.

Also of interest is information of what a group member may want to watch but is not currently watching. For example, a group member probably only stores programming content on a DVR when that content is of interest to him. Thus, scanning the contents stored on the DVR gives insight into that group member's interests.

For just one more example, if a group member posts a review of some content on-line, it may be assumed that the group member viewed the content. The nature of the review indicates whether or not the group member enjoyed the content.

The above are only a few examples of the type of content-consumption information that may be interest for the present invention. Different circumstances allow access to different types of information, and different users produce different information. Privacy issues should, of course, be addressed. Also, in a household with multiple members, it might not be possible to assign specific content-consumption information to a specific member of the household. These are all well known problems, and though they have not all been adequately solved, useful approaches are known that can be used by the present invention in step 300 of FIG. 3a to gather useful and appropriate information.

In step 302 of FIG. 3a, the gathered content-consumption information is collected at a “controller.” This controller may be at the head-end server 104 of FIG. 1, but it may also be located somewhere on the web. Its specific implementation is not very relevant. Simply put, it needs to collect the content-consumption information for the group members (and know that the information it is collecting is relevant to this particular group). This collection is contemplated to be an ongoing activity: The more content-consumption information gathered about the group members, and the longer the period over which such information is gathered, the more accurate can be the results produced by the controller based on this information.

The primary result produced by the controller is a shared social program guide (step 304). In some embodiments, the controller sifts through the enormous amount of available content (available, for example, from the cable provider, from web-based providers, and stored by group members) and, based on the gathered content-consumption information, selects content that may be of interest to all of the members of the social group. Those selections are then presented in a shared social program guide.

Now is as good a time as any to note that any social network is a fluid concept. Members come and go. As a simple example, in some embodiments the controller knows, from the gathered content-consumption information, which group members are actually currently watching television (or are known to often watch television at this time). The other (non-participating) group members may be irrelevant for now, and the controller may choose to ignore the content-consumption information gathered about those not-participating group members when it selects the content to put onto the shared social program guide.

In any case, the controller sends its created shared social program guide to the devices (probably the set-top boxes 108) of the participating group members in step 304. The shared social program guide is presented to the participating group members in step 306.

Interaction program guides are well known in the art, and the set-top box 108 may be safely assumed to know how to present such a guide. The program guide of the present invention is unique in that it does not give access to the universe of available content but rather to a subset of that content selected as potentially interesting to all members of the social network. Any known or afterward-developed implementations of program guides can be used here. For example, a simple text menu of the selected content can be presented on the television monitor 110, and a participating group member can interact with the guide via a standard television remote control. A more sophisticated guide can show previews or actual snippets of the content on the guide. The guide may even be presented to a participating group member's laptop computer 112 or cellular telephone rather than to the television monitor 110. The known art of interactive program guides is full of possibilities that may be used in conjunction with the present invention.

In step 308, participating group members interact with the shared social program guide as they would with a prior-art program guide. However, in some embodiments, the interaction of each group member is coordinated with all of the other participating group members. Thus, one group member can highlight a selection and propose that the entire group watch it. In the simplest scenario, the selected content in then rendered to the devices of all of the participating group members in step 310. To enhance social interactivity, the rendering is coordinated among the devices of the participating group members (for example, all participating group members see the same frame of a video at the same instant).

A basic embodiment of the present invention is presented in steps 300 through 310 of FIG. 3a. Using the present invention, the participating members of the group can socialize by watching a program in a concerted fashion, even though the group members may be dispersed throughout the world.

Note that for purposes of clarity in exposition, the content is “viewed” in the above description. As discussed earlier, aspects of the present invention may be applied to any deliverable content of any type, whether live or recorded.

The steps of FIG. 3b present some options that, in some scenarios, can enhance the basic embodiment of FIG. 3a. Note that the steps of FIG. 3b do not necessarily occur after the steps of FIG. 3a: In general, the steps of FIG. 3b, if used at all, are intermingled among the steps of FIG. 3a.

Step 312 of FIG. 3b emphasizes that the content-consumption information gathered in step 300 of FIG. 3a can include rating information generated by the group members. For example, the controller when creating the shared social program guide may choose to not include content that one group member has rated very poorly, even if other group members may be interested in watching it. Ratings can be more general than “good” or “bad” and may include, for example, appropriateness criterion. If a group member wishes to participate with his children, then the controller may automatically tailor the shared social program guide appropriately.

Step 314 sets up a communications channel among the participating group members. For example, a voice telephony bridge is initiated so that the participating group members can discuss the content as they view it. Along with this, the shared social program guide can display a list of the group members that are currently participating.

The shared social program guide need not be controlled entirely by the controller. In step 316, participating group members can alter the content on the guide. For example, while the participating group members are deciding what to watch, one group member may choose to delete from the guide a program that he really does not want to see, or another member can add a program that he has stored and that he believes the participating group members may be interested in. If the shared social program guide gets too big (the original problem being addressed by the present invention), then the users can trim it down to make their decision process easier.

Step 318 allows the participating group members to alter the rendering of the selected content, just as they would when viewing content in a non-social setting. Thus, the rendering can be paused or backed up, and that command would apply to all of the participating devices so that the rendering stays coordinated.

Although not actually a part of the shared social program guide, it is understood that the information used to create this guide may be of significant value in targeting advertising to the group members. Of course, using the information in this manner triggers concerns about privacy and “general annoyance” at advertisers.

In view of the many possible embodiments to which the principles of the present invention may be applied, it should be recognized that the embodiments described herein with respect to the drawing figures are meant to be illustrative only and should not be taken as limiting the scope of the invention. For example, the methods of the present invention can be applied to any deliverable content, recorded or live, over any communications medium or any combination of communications media. Therefore, the invention as described herein contemplates all such embodiments as may come within the scope of the following claims and equivalents thereof.

We claim:

1. In an environment with a controller in communication with a plurality of content-consumption devices, each content-consumption device associated with at least one user, a method for the controller to coordinate content consumption among a plurality of the users, the method comprising:
receiving content-consumption information from a plurality of the content-consumption devices;
based, at least in part, on the received content-consumption information, creating a shared social program guide;
presenting the shared social program guide to a plurality of the users;
receiving a content-selection command from a user; and
in response to the received content-selection command, directing a plurality of the content-consumption devices to render the selected content, the rendering coordinated among the content-consumption devices.

2. The method of claim 1 wherein the content-consumption devices are selected from the group consisting of: television, radio, set-top box, personal computer, digital video recorder, and mobile telephone.

3. The method of claim 1 wherein the users are in a social network.

4. The controller of claim 1 wherein content-consumption information comprises an element selected from the list consisting of: power usage of a content-consumption device, a command sent to a content-consumption device, information regarding content delivered to a content-consumption device, information regarding contents of a library, and a user's rating of content.

5. The method of claim 1 wherein the shared social program guide is presented to a user on a device other than a content-consumption device directed to render the selected content.

6. The method of claim 1 wherein presenting comprises presenting only to those users who are currently consuming content.

7. The method of claim 6 further comprising:
presenting to a user currently consuming content a list of other users who are currently consuming content.

8. The method of claim 1 further comprising:
receiving, from at least one of the plurality of users, content-rating information;
wherein the shared social program guide is based, at least in part, on the received content-rating information.

9. The method claim 1 further comprising:
setting up a communication channel among a plurality of the users.

10. The method of claim 1 further comprising:
during the rendering, receiving from a user a command to alter the rendering; and
based, at least in part, on the received alter-rendering command, directing a plurality of the content-consumption devices to alter the rendering, the altered rendering coordinated among the content-consumption devices.

11. The method of claim 10 wherein the alter-rendering command is selected from the group consisting of: stop, pause, rewind, fast forward, resume play, and present the shared social program guide.

12. The method of claim 1 further comprising:
receiving a command from a user to alter the shared social program guide; and
based, at least in part, on the received alter-guide command, altering the shared social program guide.

13. The method of claim 12 wherein the alter-guide command guide is selected from the group consisting of: add a selection to the guide, delete a selection from the guide, hide a selection in the guide, highlight a selection in the guide, and rate a selection in the guide.

14. A controller configured for coordinating content consumption among a plurality of users, the controller comprising:
a communication interface; and
a processor operatively coupled to the communication interface, the processor configured for:
receiving, via the communication interface, content-consumption information from a plurality of content-consumption devices, each content-consumption device associated with at least one user;
based, at least in part, on the received content-consumption information, creating a shared social program guide;
presenting, via the communication interface, the shared social program guide to a plurality of the users;
receiving, via the communication interface, a content-selection command from a user; and
in response to the received content-selection command, directing a plurality of the content-consumption devices to render the selected content, the rendering coordinated among the content-consumption devices.

15. The controller of claim 14 wherein content-consumption information comprises an element selected from the list consisting of: power usage of a content-consumption device, a command sent to a content-consumption device, information regarding content delivered to a content-consumption device, information regarding contents of a library, and a user's rating of content.

16. The controller of claim 14 wherein the shared social program guide is presented, to a user via the communication interface, on a device other than a content-consumption device directed to render the selected content.

17. The controller of claim 14 wherein the processor is further configured for:
setting up a communication channel among a plurality of the users.

18. The controller of claim 14 wherein the processor is further configured for:
during the rendering, receiving, from a user via the communication interface, a command to alter the rendering; and
based, at least in part, on the received alter-rendering command, directing a plurality of the content-consumption devices to alter the rendering, the altered rendering coordinated among the content-consumption devices.

19. A method for a content-consumption device to assist in coordinating content consumption among a plurality of users, the content-consumption device associated with at least one user, the method comprising:
collecting content-consumption information;
sending the collected content-consumption information to a controller;
receiving, from the controller, a shared social program guide;
presenting the shared social program guide to the user;
receiving a content-selection command from the user;
sending the received content-selection command to the controller; and
based, at least in part, on information received from the controller, rendering content to the user.

20. A content-consumption device for assisting in coordinating content consumption among a plurality of users, the content-consumption device associated with at least one user, the content-consumption device comprising:
a communication interface; and
a processor operatively coupled to the communication interface, the processor configured for:
collecting content-consumption information;
sending, via the communication interface, the collected content-consumption information to a controller;
receiving, from the controller via the communication interface, a shared social program guide;
presenting the shared social program guide to the user;
receiving a content-selection command from the user;
sending, via the communication interface, the received content-selection command to the controller; and
based, at least in part, on information received from the controller, rendering content to the user.
